(19) United States
(12) Patent Application Publication
(10) Pub. No.: US 2021/0072027 A1
(43) Pub. Date: Mar. 11, 2021

(54) SYSTEMS AND METHODS FOR PROVIDING LOCALIZATION AND NAVIGATION SERVICES

(71) Applicant: CACI, Inc. - Federal, Arlington, VA (US)

(72) Inventors: Michael S. Marques, Westminster, CO (US); Scott R. Linemeyer, Broomfield, CO (US); Gregory J. Mueller, Arvada, CO (US)

(21) Appl. No.: 17/014,223

(22) Filed: Sep. 8, 2020

Related U.S. Application Data
(60) Provisional application No. 62/897,516, filed on Sep. 9, 2019.

(51) Int. Cl. G01C 21/20; H04W 4/021; H04W 4/024; H04W 4/33; G01S 5/14

(52) U.S. Cl. CPC G01C 21/206; H04W 4/021; G01S 5/14; H04W 4/33; H04W 4/024

(57) ABSTRACT

A system may be configured to indicate a path for a user in a closed environment. Some embodiments may: determine a location of a user by walking down an error surface, until reaching a minimum, the error surface having a length represented by a brightness of a rendering; and indicate a path for the user to a nearest point of interest (POI) based on the determined location.

### CROSS-REFERENCE TO RELATED APPLICATIONS

This application claims the benefit of the priority date of U.S. provisional application 62/897,516 filed on Sep. 9, 2019 and entitled “Systems and Methods for Providing Localization and Navigation Services,” the content of which is incorporated by reference herein in its entirety.

### TECHNICAL FIELD

The present disclosure relates generally to systems and methods for guiding users along one or more paths in an enclosed space.

### BACKGROUND

A significant problem in the art relates to ways of guiding visually impaired individuals through interior structures (e.g., homes, buildings, workplaces, etc.). What is desired in the art is localization and navigation technology that may overcome known deficiencies.

### SUMMARY

Systems and methods are disclosed for guiding visually impaired people. Accordingly, one or more aspects of the present disclosure relate to a method for: determining a location of a user by walking down an error surface, until reaching a minimum, the error surface having a length represented by a brightness of a rendering; and indicating a path for the user to a nearest point of interest (POI) based on the determined location.

The method is implemented by a system comprising one or more hardware processors configured by machine-readable instructions and/or other components. The system comprises the one or more processors and other components or media, e.g., upon which machine-readable instructions may be executed. Implementations of any of the described techniques and architectures may include a method or process, an apparatus, a device, a machine, a system, or instructions stored on computer-readable storage device(s).

### BRIEF DESCRIPTION OF THE DRAWINGS

The details of particular implementations are set forth in the accompanying drawings and description below. Like reference numerals may refer to like elements throughout the specification. Other features will be apparent from the following description, including the drawings and claims. The drawings, though, are for the purposes of illustration and description only and are not intended as a definition of the limits of the disclosure.

FIG. 1 illustrates an example of a system in which a user may be provided guidance for navigating occupied spaces, in accordance with one or more embodiments.

FIG. 2 illustrates an interior floorplan of a space within which a user is guided, in accordance with one or more embodiments.

FIG. 3 illustrates an example of an environment geometry among exemplary grid cells for determining traversability, in accordance with one or more embodiments.

FIG. 4 illustrates a spiral search beginning to find a nearest connected cell, in accordance with one or more embodiments.

FIG. 5 illustrates a process for implementing a multi-lateration algorithm as part of a navigation service, in accordance with one or more embodiments.

FIG. 6 illustrates a process for providing path prediction and optimization to statically-located POIs of an environment, in accordance with one or more embodiments.

FIG. 7 illustrates a process for providing path prediction and optimization based on other users dynamically moving in an environment, in accordance with one or more embodiments.

### DETAILED DESCRIPTION

As used throughout this application, the word “may” is used in a permissive sense (i.e., meaning having the potential to), rather than the mandatory sense (i.e., meaning must). The words “include,” “including,” and “includes” and the like mean including, but not limited to. As used herein, the singular form of “a,” “an,” and “the” include plural references unless the context clearly dictates otherwise. As employed herein, the term “number” shall mean one or an integer greater than one (i.e., a plurality).

As used herein, the statement that two or more parts or components are “coupled” shall mean that the parts are joined or operate together either directly or indirectly, i.e., through one or more intermediate parts or components, so long as a link occurs. As used herein, “directly coupled” means that two elements are directly in contact with each other. As used herein, “fixedly coupled” or “fixed” means that two components are coupled so as to move as one while maintaining a constant orientation relative to each other. Directional phrases used herein, such as, for example and without limitation, top, bottom, left, right, upper, lower, front, back, and derivatives thereof, relate to the orientation of the elements shown in the drawings and are not limiting upon the claims unless expressly recited therein.

These drawings may not be drawn to scale and may not precisely reflect structure or performance characteristics of any given embodiment, and should not be interpreted as defining or limiting the range of values or properties encompassed by example embodiments.

Unless specifically stated otherwise, as apparent from the discussion, it is appreciated that throughout this specification discussions utilizing terms such as “processing,” “computing,” “calculating,” “determining,” or the like refer to actions or processes of a specific apparatus, such as a special purpose computer or a similar special purpose electronic processing/computing device.

Presently disclosed is system 10 that implements artificial intelligence (AI) in performing multi-lateration and/or in guiding a user through a space. Various needs are met by the disclosed approach. For example, the disclosed approach may provide localization and navigation services for visually impaired individuals. For example, in the coverage area provided by anchor devices, localization may be provided entirely without use of a global positioning system (GPS).

The disclosed multi-lateration may be based on measurement of the times of arrival (TOAs) of energy waves (e.g., radio, acoustic, seismic, etc.) having a known propagation speed and may be used to locate a user as part of the herein-disclosed navigation technique. Prior to computing a solution, the time of transmission of the waves may be unknown to the receiver.

One aspect of the disclosed approach may include using the determined position information to provide the user with information about what is around them. For example, as the user moves through a space, they may receive audio and/or haptic prompts that indicate an obstacle or the nearest point of interest (POI). In this or another example, if the user moves into another region, they may receive a verbal announcement of the new area's name. The position information may also be used to guide the user to POIs, in the area.

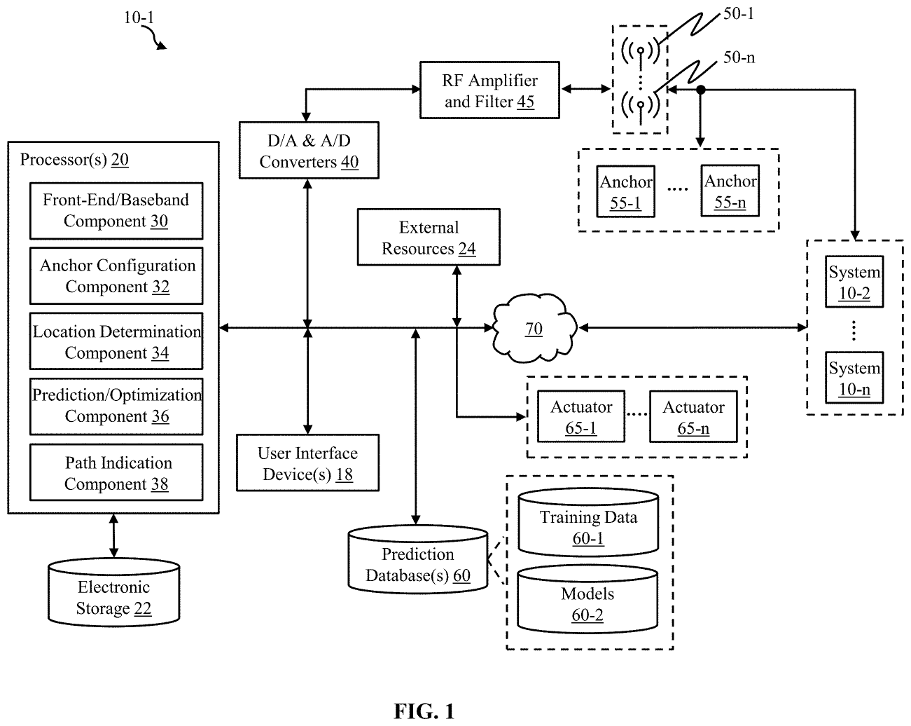

System 10 (e.g., 10-1) of FIG. 1 comprises electronic storage 22, which is electronic storage media that electronically stores information. The electronic storage media of electronic storage 22 may comprise system storage that is provided integrally (i.e., substantially non-removable) with system 10 and/or removable storage that is removably connectable to system 10 via, for example, a port (e.g., a USB port, a firewire port, etc.) or a drive (e.g., a disk drive, etc.). Electronic storage 22 may be (in whole or in part) a separate component within system 10, or electronic storage 22 may be provided (in whole or in part) integrally with one or more other components of system 10 (e.g., a user interface (UI) device 18, processor 20, etc.). In some embodiments, electronic storage 22 may be located in a server together with processor 20, in a server that is part of external resources 24, in user interface devices 18, and/or in other locations. Electronic storage 22 may comprise a memory controller and one or more of optically readable storage media (e.g., optical disks, etc.), magnetically readable storage media (e.g., magnetic tape, magnetic hard drive, floppy drive, etc.), electrical charge-based storage media (e.g., EPROM, RAM, etc.), solid-state storage media (e.g., flash drive, etc.), and/or other electronically readable storage media. Electronic storage 22 may store software algorithms, information obtained and/or determined by processor 20, information received via user interface devices 18 and/or other external computing systems, information received from external resources 24, and/or other information that enables system 10 to function as described herein.

External resources 24 may include sources of information (e.g., databases, websites, etc.), external entities participating with system 10, one or more servers outside of system 10, a network, electronic storage, equipment related to Wi-Fi technology, equipment related to Bluetooth® technology, data entry devices, a power supply (e.g., battery powered or line-power connected, such as directly to 110 volts AC or indirectly via AC/DC conversion), a transmit/receive element (e.g., an antenna configured to transmit and/or receive wireless signals), a network interface controller (NIC), a display controller, a graphics processing unit (GPU), and/or other resources. In some implementations, some or all of the functionality attributed herein to external resources 24 may be provided by other components or resources included in system 10. Processor 20, external resources 24, user interface device 18, electronic storage 22, a network, and/or other components of system 10 may be configured to communicate with each other via wired and/or wireless connections, such as a network (e.g., a local area network (LAN), the Internet, a wide area network (WAN), a radio access network (RAN), a public switched telephone network (PSTN), etc.), cellular technology (e.g., GSM, UMTS, LTE, 5G, etc.), Wi-Fi technology, another wireless communications link (e.g., radio frequency (RF), microwave, infrared (IR), ultraviolet (UV), visible light, cm wave, mm wave, etc.), a base station, and/or other resources.

User interface device(s) 18 of system 10 may be configured to provide an interface between one or more users and system 10. User interface devices 18 are configured to provide information to and/or receive information from the one or more users. User interface devices 18 include a user interface and/or other components. The user interface may be and/or include a graphical user interface configured to present views and/or fields configured to receive entry and/or selection with respect to particular functionality of system 10, and/or provide and/or receive other information. In some embodiments, the user interface of user interface devices 18 may include a plurality of separate interfaces associated with processors 20 and/or other components of system 10. Examples of interface devices suitable for inclusion in user interface device 18 include a touch screen, a keypad, touch sensitive and/or physical buttons, switches, a keyboard, knobs, levers, a display, speakers, a microphone, an indicator light, an audible alarm, a printer, and/or other interface devices. The present disclosure also contemplates that user interface devices 18 include a removable storage interface. In this example, information may be loaded into user interface devices 18 from removable storage (e.g., a smart card, a flash drive, a removable disk) that enables users to customize the implementation of user interface devices 18.

In some embodiments, user interface devices 18 are configured to provide a user interface, processing capabilities, databases, and/or electronic storage to system 10. As such, user interface devices 18 may include processors 20, electronic storage 22, external resources 24, and/or other components of system 10. In some embodiments, user interface devices 18 are connected to a network (e.g., the Internet). In some embodiments, user interface devices 18 do not include processor 20, electronic storage 22, external resources 24, and/or other components of system 10, but instead communicate with these components via dedicated lines, a bus, a switch, network, or other communication means. The communication may be wireless or wired. In some embodiments, user interface devices 18 are laptops, desktop computers, smartphones, tablet computers, and/or other user interface devices.

Data and content may be exchanged between the various components of system 10 through a communication interface and communication paths using any one of a number of communications protocols. In one example, data may be exchanged employing a protocol used for communicating data across a packet-switched internetwork using, for example, the Internet Protocol Suite, also referred to as TCP/IP. The data and content may be delivered using datagrams (or packets) from the source host to the destination host solely based on their addresses. For this purpose the Internet Protocol (IP) defines addressing methods and structures for datagram encapsulation. Of course other protocols also may be used. Examples of an Internet protocol include Internet Protocol Version 4 (IPv4) and Internet Protocol Version 6 (IPv6).

In some embodiments, processor(s) 20 may form part (e.g., in a same or separate housing) of a user device, a consumer electronics device, a mobile phone, a smartphone, a personal data assistant, a digital tablet/pad computer, a wearable device (e.g., watch), augmented reality (AR) goggles, virtual reality (VR) goggles, a reflective display, a personal computer, a laptop computer, a notebook computer, a work station, a server, a high performance computer (HPC), a vehicle (e.g., embedded computer, such as in a dashboard or in front of a seated occupant of an autonomous driving car), a game or entertainment system, a set-top-box, a monitor, a television (TV), a panel, or any other device. In some embodiments, processor 20 is configured to provide information processing capabilities in system 10. Processor 20 may comprise one or more of a digital processor, an analog processor, a digital circuit designed to process information, an analog circuit designed to process information, a state machine, and/or other mechanisms for electronically processing information. Although processor 20 is shown in FIG. 1 as a single entity, this is for illustrative purposes only. In some embodiments, processor 20 may comprise a plurality of processing units. These processing units may be physically located within the same device or housing, or processor 20 may represent processing functionality of a plurality of devices operating in coordination (e.g., one or more computers, user interface devices 18, devices that are part of external resources 24, electronic storage 22, and/or other devices).

As shown in FIG. 1, processor 20 is configured via machine-readable instructions to execute one or more computer program components. The computer program components may comprise one or more of front-end/baseband component 30, anchor configuration component 32, location determination component 34, prediction/optimization component 36, path indication component 38, and/or other components. Processor 20 may be configured to execute components 30, 32, 34, 36, and/or 38 by: software; hardware; firmware; some combination of software, hardware, and/or firmware; and/or other mechanisms for configuring processing capabilities on processor 20.

It should be appreciated that although components 30, 32, 34, 36, and 38 are illustrated in FIG. 1 as being co-located within a single processing unit, in embodiments in which processor 20 comprises multiple processing units, one or more of components 30, 32, 34, 36, and/or 38 may be located remotely from the other components. For example, in some embodiments, each of processor components 30, 32, 34, 36, and 38 may comprise a separate and distinct set of processors. The description of the functionality provided by the different components 30, 32, 34, 36, and/or 38 described below is for illustrative purposes, and is not intended to be limiting, as any of components 30, 32, 34, 36, and/or 38 may provide more or less functionality than is described. For example, one or more of components 30, 32, 34, 36, and/or 38 may be eliminated, and some or all of its functionality may be provided by other components 30, 32, 34, 36, and/or 38. As another example, processor 20 may be configured to execute one or more additional components that may perform some or all of the functionality attributed below to one of components 30, 32, 34, 36, and/or 38.

Herein disclosed is a wearable tag, which comprises a small radio transponder; a radio receiver and transmitter. This RF tag may be integrated in a wearable accessory or garment to compute a distance to each of the anchor transceivers. As such, the tag may be attached to clothing and possessions, or it may be implanted in an animal or person. The tag may be passive or powered by energy from the anchors' radio waves. But in other embodiments the tag may be powered by a battery. Other worn components of system 10 may similarly be battery powered.

In some implementations, the tag may comprise one or more components of processor(s) 20, digital to analog (D/A) and analog to digital (A/D) converters 40, RF amplifier and filter 45, one or more external resources 24, one or more user interface devices 18, electronic storage 22, one or more antennas 50 (e.g., 50-1 . . . 50-n, n being any natural number), and potentially another component. And the tag may exemplarily be worn by the user (e.g., mounted in a vest), or it may form part of an electromechanical conveyor or wheelchair of the user.

In some embodiments, guidance may be provided with haptic feedback signals (e.g., via vibration motors 65 embedded within the vest the user is wearing) that may indicate to the user which direction to walk to reach the POI. In other embodiments (i.e., where the haptic motors are not used), guidance may be provided with audio signals. Path planning may be performed with a map of the area to be navigated to provide the user with walking directions, which do not intersect known obstacles.

In some embodiments, one or more actuators 65 may comprise a transducer or generator. In these or other embodiments, the actuator(s) may be a speaker diaphragm, a light emitting diode (LED), a panel or display, a vibrator, a sensory probe, a haptic or force feedback control device, and/or another component of system 10 suitable for indicating recommendations for the user's movements.

In some embodiments, RF amplifier and filter 45 may comprise an amplifier that amplifies low-power signals (e.g., without significantly degrading a signal-to-noise (SNR) ratio). The amplifier may increase the power of both the signal and the noise present at its input, but such low-noise amplifier (LNA) may be designed to minimize additional noise (e.g., including trade-offs based on impedance matching, low-noise components, biasing conditions, etc.). In these or other embodiments, RF amplifier and filter 45 may comprise a bandpass filter (BPF) and one or more low-pass filters (LPFs) for signals being input at the tag. And RF amplifier and filter 45 may further comprise a mixer, e.g., which operates from an output of a phase-locked loop (PLL)/voltage controlled oscillator (VCO).

After performing packaging and/or encoding functions, D/A converter 40 may obtain and forward data to RF amplifier 45 before antenna 50 emits the data to anchors 55 and/or other systems 10 (e.g., 10-2 . . . 10-n, n being any natural number). Component 45 may further include a filter, when receiving signals from anchors 55 and/or other systems 10.

A decoding unit, such as component 30, may process emissions (e.g., from anchors 55 and other users' systems 10) and perform correction by detecting and filling gaps in channel information, e.g., via error correction or diversity techniques. Upon reception of such emissions, the digital, baseband signals may exemplarily be provided to front-end/baseband component 30 for further processing. For example, front-end/baseband component 30 may demodulate signals, e.g., when operating as a software defined radio.

In some embodiments, front-end/baseband component 30 of system 10-1 may perform a demodulation and a decoding of modulated and encoded data (e.g., emitted from anchors 55 and other users' systems 10). In these or other embodiments, front-end/baseband component 30 may perform digital channelization and sample rate conversion. In some embodiments, front-end/baseband component 30 may perform functionality that includes data control, error correction coding (ECC), and/or cryptography (e.g., encryption, decryption, key handling, etc.). In these embodiments, this component may further perform modulation and coding (e.g., via known networking techniques), for emissions to anchors 55 and/or other users' systems 10. In these or other embodiments, at least some of this functionality is performed using an embedded field programmable gate array (FPGA) or via digital signal processing (DSP). System 10-1 may perform baseband processing such that a digital signal converted to analog by converter 40 is mixed to an intermediate frequency (IF) and then to RF, while being amplified by amplifier 45.

In some implementations, the housing for processors 20 may be distinct from or further comprise AR or VR goggles. Or connected to such housing (e.g., wired or wirelessly) may be another housing, which may comprise the worn tag and/or worn actuators 65 (e.g., 65-1 . . . 65-n, n being any natural number). The goggles may comprise diffractive waveguides or reflective waveguides. The AR or VR goggles may perform optical projection and interface with handheld devices or worn components of system 10. These goggles may be a headset, head-mounted display (HMD), eyeglasses, contact lenses, virtual retinal display, or another suitable fixture. In some implementations, each of the users of the closed environment may wear a set of VR and/or AR goggles.

In some embodiments, external resources 24 may include one or more ambient sensors of the user's environment (e.g., car, office, building, room, bathroom, etc.) to collect information about the actual lighting conditions (e.g., room lighting and/or seasonal lighting conditions) in the environment, activities of other users within the environment, and the like.

Any of the herein disclosed sensors may be implemented via external resources 24. For example, these sensors may include one or more of a light exposure sensor or camera (e.g., to capture colors and sizes of nearby objects), motion sensor, infrared (IR) sensor, oxygen sensor, temperature sensor, video camera, microwave sensor, LIDAR, microphone, olfactory sensor, haptic sensor, bodily secretion sensor (e.g., pheromones), ultrasound sensor, and/or another sensing device. In some embodiments, external resources 24 may form part of a pendant, an armband, a wrist band, a dongle, a tag, a watch, a chest band, glasses, clothing, a headset, an activity tracker, and the like.

The tag may contain hardware (e.g., micro-controller, antennas, etc.) for using RF to measure distances to anchors 55. Anchors 55 may be mounted throughout an area, in which the user will be using the device to navigate, and all of the anchors may have known positions. A configuration or spacing between anchors 55 may depend heavily on the building layout. For example a structure may include columns, corners, and other architectural features; and tight hallways may necessitate more anchors 55 than large open rooms, per unit area. In some implementations, anchors 55 may be evenly spaced, e.g., at 10 meter intervals. In a hallway, the anchors may be interleaved, e.g., where one such anchor is located on either side and at every 5 meters of hallway distance. In large empty rooms (e.g., a conference room with high ceilings and few obstructions), it may be possible to have wider spacings. In more cluttered areas, the density may be higher. For example, in a 600 square-meter space with many large displays and objects hanging from the ceiling, the required density may be much higher by using 11 anchors such that there is a density of 1 anchor per 55 square-meters. In a hall adjacent to this space, there may be 13 anchors covering a 1080 square-meter area such that there is a density of 1 anchor per 84 square-meters. In another, narrower hall adjacent to this space, there may be 4 anchors covering 70 square-meters such that there is a density of 1 anchor per 18 square-meters.

The distances to each of the anchors may be used in a multi-lateration algorithm to compute the user position. A precision requirement of the multi-lateration result may be based on an accuracy of the ranging used, which itself is a function of the relative position, density, configuration, environmental obstructions, and/or device placement on the user. In an exemplary implementation, a DW1000 chipset from Decawave may be used to facilitate ranging. With a density similar to or on the order of the previously described space and with positioning of a tag on the shoulder, typical measurement accuracy may be on the order of 10 centimeters (cm) standard deviation. The radio settings may be optimized for typical indoor ranging with high multipath characteristics, e.g., by tuning the non-line-of-sight (NLOS) thresholds for first path detection and for many other radio parameters. NLOS may refer to the path of propagation of an RF signal that is obscured (partially or completely) by obstacles, thus making it difficult for the radio signal to pass through.

In some embodiments, POIs may be determined by user-provided instruction, and/or they may be determined by a server. In these or other embodiments, the POIs may be preloaded into the application. For example, various regions of each space may be loaded into the application; each of these regions may be an exhibit of a museum, a bathroom, a location for placing signage, a security desk, or a location of another guest service. The POIs may be provided by the management of the space in which system 10 is installed. For example, the space manager may provide exhibit names and/or descriptions for the POIs that are to be integrated into a map, which an application running on processor(s) 20 uses to provide information to the user.

The user may interact with the system through an application. The application may connect to the tag (e.g., via Bluetooth LE). A simple pairing process using near field communication (NFC) may be implemented. Once connected, the application may provide the user with information about their surroundings and an interface to request start of navigation. The application may obtain positional information from the tag. And if the user comes within range of a POI or transitions into its region, an audio announcement may be made.

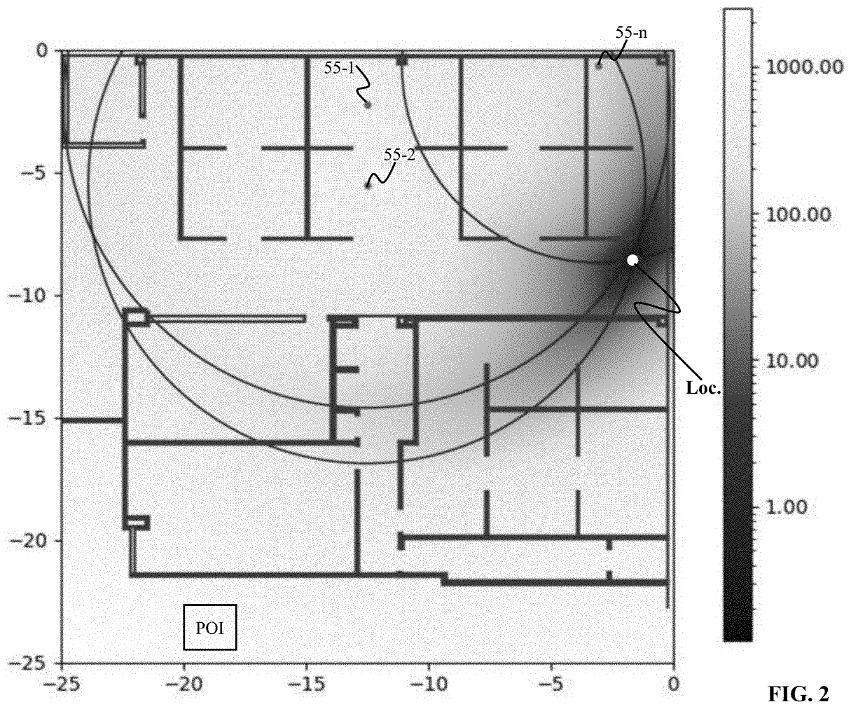

FIG. 2 provides an exemplary visualization of the sum of the square of the distance measurement errors in a heatmap for localizing. The estimated location of a user is exemplarily shown as a white circle on the map. Three anchors 55 and the arcs/rings may represent the distance measurements. In some embodiments, two or three anchors 55 are a minimum number, but more anchors may be used as more measurements typically result in a more accurate localization. The X-Y axes of FIG. 2 correspond to distances in meters on the map. The scale of the lightness is the square of the error of the position estimate. It is the sum of the square of the error in each measurement. So it could be thought of as error (e.g., in square meters). The darker areas of the image have the lowest error.

The map geometry, which is depicted in FIG. 2 with various turns at right-angles, may represent the local area. There may be some measurement uncertainty, which may result in the 3 arcs/rings not overlapping at a single point. The gradient descent algorithm may be used to walk down the error surface, which may have its height represented by the lightness of the shading in the heatmap, until it reaches the minimum. This may be the estimated position. The disclosed approach may consider as many distance measurements as desired. This desire may be based on an inherent tradeoff between tag density and a number of measurements. That is, more measurements may provide better localization, but they may also require more airtime, which decreases the total number of tags able to localize themselves in an area. More measurements may also require more power, reducing the battery life of the tag.

For each position, there may be an error between what was measured and the actual distance between anchor 55 and that position. An error surface may be defined by the sum of the squares of the errors of each anchor measurement based on the anchor position. That error value may be the value of that position on the surface. To minimize the error, a movement may be performed along the surface (e.g., which may be in incremental steps along the surface) to a point with a lower error, which may be represented by a lower value of the surface. To walk down the surface is to minimize the error. And the position of minimal error is the mostly likely location given the measured data.

Aspects of the system robustness will now be discussed. To increase system robustness, a distributed architecture may be chosen. Anchors 55 may be preconfigured with their position in space. The localization running on the tag itself may allow it to be independent of an outside source for computation. Anchors 55 may not talk to each other. The tag may query nearby anchors for their position in space and then use the measurements to these anchors to determine its position in space, without any other, outside help.

In some embodiments, anchor configuration component 32 may configure a closed environment with a plurality of anchor transceivers 55 at different locations. These anchors may exemplarily be deployed as a mesh network.

In some embodiments, anchor configuration component 32 may initially (e.g., preset during system installation based on the physical space) and/or dynamically (e.g., using proximity sensors in relation to potential paths) configure an environment for optimal locations of the anchors. The dynamic configuration capability may comprise the anchors self-configuring with respect to one another through an auto-calibration activity. Anchor configuration component 32 may configure a substantially closed environment with a plurality of anchor transceivers 55 at different locations in relation to one or more paths to be taken by a user. The substantially closed environment may comprise walls, roofs, floors, openable windows, rooms, halls, and/or openable doors (e.g., of a museum or another building or structure). And anchors 55 may be mounted high on walls or on tripods, e.g., which are preferably above head height. Each anchor 55 may be powered via USB, a battery, and/or a wall outlet.

All that may be required for a tag to localize itself may be anchors 55 in its immediate vicinity to be functional. For example, no central server may be required. This may be achieved by having the anchors know and report their own position, which may allow a tag not configured for the given area to immediately know its position in that area. Ranging and computation of the devices position may all be done onboard, effectively removing the need for additional connectivity or outside resources.

A ranging session may be initiated by a poll request from the tag. Any anchors in the area may hear its request and if these anchors are listed in the poll request, they may reply with a time delay defined by their position in the list. After each anchor replies, there may be one more exchange to complete the range measurement. Once all the anchors in the poll have replied (or failed to reply in their allotted time slot) a ranging session is complete and a position can be computed.

Aspects of the RF localization technology will now be discussed. The localization of the tag device may be enabled by ultra-wide band RF radios with time-of-flight measurement capability. The chipset used may be, e.g., the DW1000 from DecaWave. Some embodiments may thus implement RF ranging.

In some embodiments, the DW1000 exemplarily of each anchor 55 may support Internet of things (IoT) applications and communications of around (or up to) 6.8 megabits per second (Mbps). The DW1000 may form a single chip and serve as a wireless transceiver based on ultra-wideband (UWB) techniques. As such, the anchors may provide a real-time location system (RTLS) having precise indoor and outdoor positioning to within 10 centimeters (cm).

In some embodiments, the herein disclosed tag may utilize time difference of arrival (TDOA), which determines a difference in arrival time between the physically separate anchors to derive the tag's location. That is, as long as the anchors' time base are synchronized, an embodiment then can use the difference in the arrival time at each of the anchors to work out where the tag is.

In some embodiments, the tags may be used to measure a distance from the user wearing the tag to each of one or more anchors. This ranging function may be performed by exchanging messages (e.g., in two-way ranging, two devices communicate) that share a time that the respective message is emitted from a first device (e.g., from a first antenna of a tag initiator) and received at a second device (e.g., from a second antenna of an anchor responder). From these time stamps, the devices may calculate the time of flight (TOF) from a first antenna (e.g., of the tag) to a second antenna (e.g., of one of the anchors) and use the known speed of light to then calculate a distance between them, as shown by equation 1 below.

Distance=Speed of radio waves×TOF (1)

This equation can apply to ranging where the TOF is calculated in roundtrip communication by subtracting a time the responder takes to respond to an initial message. Ranging may begin with a discovery phase that transitions into the ranging phase. In the discovery phase, the tag may periodically send a blink message that contains its own address and listens for a response from an anchor. If the tag does not get this response, it may sleep for a period (e.g., 1 second) before blinking again. In the ranging phase, the tag may periodically perform two-way ranging exchanges with the anchor, including a sending of a poll message, receiving a responsive message, and then sending a final message. The final message may be sent by the tag after receiving the anchor's response message. Each of these messages may comprise one or more bytes of patterned data. As such, the tag may emit messages (e.g., on a periodic or otherwise scheduled basis) and all anchors in range may respond to each message.

The worn tag and installed anchors 55 (e.g., 55-1 . . . 55-n, n being any natural number) may utilize UWB technology to determine the TOF of the transmission at various frequencies, e.g., to overcome multipath propagation, as at least some of the frequencies may have a line-of-sight (LOS) trajectory. With a cooperative symmetric two-way metering technique, distances can be measured to high resolution and accuracy by compensating for local clock drift and stochastic inaccuracy.

The time stamps may be implemented via mathematical and electronic manipulation of a very precise clock. More particularly, the chipset may record the state of this clock when certain events occur during transmission and reception of the radio wave signals or messages.

The used chipset may provide high accuracy time stamping (e.g., by using a 64 gigahertz (GHz) clock to accurately timestamp data, as it leaves the radio) and transmission of radio packets. Asymmetric two-way ranging TOF may be used to measure the distance of the tags to the anchors. The benefit of doing TOF measurements in both directions (i.e., both from the anchor to the tag and from the tag to the anchor) may be a significant reduction in the error that comes from the relative drift in the device's crystal oscillators. A 64 GHz clock may be used to timestamp incoming and outgoing packets resulting in picosecond resolution. A calculation may be made, given the timestamps of the poll, response, and final packets, which may result in a distance measurement with an accuracy of 10 cm in cases where the LOS path was detected.

The ultra-wideband nature of the signal may reduce the influence of multipath reflections of the RF, making it easier to detect the first path that corresponds to an accurate distance. The RF signal may bounce off objects, resulting in multiple paths from the transmitter to the receiver. The first path may be the path taken by the RF signal that arrives first at the receiver. In cases where the LOS sight signal is strong enough to reach the receiver, this is the shortest path between the two and represents the true distance between them.

Further aspects of the ranging procedure will now be discussed. Localization may be done by measuring the range to the anchors in the local vicinity. This may require knowing which anchors are in the immediate vicinity.

This may be accomplished by sending out a “who's there?” packet. Anchors 55 that hear the packet may respond with their locations. The anchors may pick a random time within a 10 millisecond window to prevent the responses from colliding. The tag may receive these and insert them into a list sorted by the received signal strength indicator (RSSI). Anchors with stronger signals may be prioritized for ranging sessions. To keep the list up to date each time a ranging session occurs, the list may be resorted by RSSI. The number of times an anchor fails to respond may be also tracked. Failure to respond 3 times in a row may result in removal from the list. A more complex system is used for filtering bad measurements based on how any individual measurements error relates to the standard deviation of the errors of all the measurements, the priority not being thus used.

In some embodiments, anchors 55 may be substantially fixed reader nodes of system 10. System 10 may comprise a bridge node (not shown) that may also be fixed and that may function as a gateway by routing data between the UWB network and network 70 (or another network).

In some embodiments, a plurality of tags may be in a same environment. A listener may thus be used to collate location information from many tags.

In some embodiments, the anchors emit UWB messages, e.g., which are compliant with IEEE 802.15.4-2011 or another suitable standard. UWB is a radio technology that can use a very low energy level for short-range, high-bandwidth communications over a large portion of the radio spectrum (e.g., greater than 500 megahertz (MHz)). Unlike spread spectrum, UWB transmits in a manner that does not interfere with conventional narrowband and carrier wave transmission in the same frequency band. For example, UWB transmissions transmit information by generating radio energy at specific time intervals, thus enabling pulse-position or time modulation. The information can also be modulated on UWB signals (pulses) by encoding the polarity of the pulse, its amplitude and/or by using orthogonal pulses. UWB pulses can be sent sporadically at relatively low pulse rates to support time or position modulation, but can also be sent at rates up to the inverse of the UWB pulse bandwidth. As such, signal reflections may not overlap an original pulse, and there may be no multipath fading of narrowband signals.

Aspects of the localization algorithm will now be discussed. Localization may be run at the completion of each ranging session. The set of measured distances, the positions of the corresponding anchors, and an estimate of the current position may be fed into a gradient descent algorithm.

At the start of system 10 operation, the current position of a user may be estimated to be the geometric center of all the anchors to which there are measurements. During normal continuous operation, it may be just the last computed position. This may allow rapid convergence of the gradient descent algorithm. If the last measurement was accurate, the user is unlikely to have moved a large distance since then. By starting the gradient descent closer to the true position, it requires less steps to reach it then if it was started at a random position or by using the weighted average of the anchors.

The algorithm may be initialized with a certain step size. This may be chosen, e.g., to be 8 meters, allowing a rapid search of the greater area before taking smaller steps to fine tune the position estimate.

Each iteration of the gradient descent algorithm may start with a computation of the current estimates error, which may be computed by taking the magnitude of the vector of the difference between the estimated position and the anchor position and by subtracting it from the measured distance. An exemplary equation for computing this error may be:

Error=|(xₜ−xₐ)²+(yₜ−yₐ)²+(z₁−zₐ)²))−MeasuredDistance| (2)

The difference between the measured and computed distance to each anchor may be calculated and squared. All the errors may be summed to compute the current error. For example, the sum of the squares may be computed with this exemplary equation:

$$Error = {\sum }_{i = 1}^{n} {e}^{2} \qquad ( 3 )$$

At each iteration, steps in each of the four cardinal directions may be taken and the error for each may be computed. If the lowest error of the four new states is less than the current error, that state may be the new position. If all directions result in a higher error, the step size may be divided in half. This approach may be used to speed up the algorithm. Initially, when far from the minimum error, larger steps may proceed closer to it. This allows for less total steps. But, when near the minimum, large steps cause movement further away from it as well as limit the resolution. If all steps lead up, the minimum must be closer than one step side. The approach thus causes reduction in the step size to increase resolution and get closer to the minimum error.

This procedure may be continued until the step size is below 5 cm. This may allow reaching convergence to within what is possible given the measurement error. Because the uncertainty in the distance measurement is typically within +/−10 cm there may be no reason to try to get closer than this in the gradient descent. The approach could continue reducing step size, but this may not provide a more accurate measurement of position.

Aspects of the measurement filtering will now be discussed. For each individual measurement made, several ways of determining the reliability of the measurement may be used.

The first layer of filtering may occur with diagnostic data from the radio. The methods described herein may be from Decawave's application notes on determining the reliability of a measurement. Said notes may provide a way to filter to improve accuracy.

The likelihood that a measurement was of a reflection or the first path may be determined from the radio diagnostic data in several ways. A first (and potentially easier way) may be to look at the index of the first path in the accumulator. A value of −700 may be typical for a line of sight detection. The accumulator may be a buffer that measures the counts of times an RF pulse was detected in a given interval due to the pulse repetition rate giving a likelihood estimate of the packet synchronization being aligned with that time bin.

The contents of the accumulator may be analyzed directly, but this may add considerable processing time to the ranging. The threshold for the first peak detection may be lowered, and the number of new first path detentions in a window in front of the first path may be counted. The number of new detentions compared to the number of possible new detentions may be a good metric for LOS/NLOS.

LOS measurements often saturate the receiver with a very high-power signal. Looking at how the first peak and the highest peak are positioned relative to one another (i.e., if they are the same) may be a good indication of LOS.

The distance measurement combined with the RSSI may be used to estimate NLOS versus LOS measurements. At a given distance, the expected RSSI for a LOS channel may be calculated. If the signal strength is less than what is expected, it may be likely that there was an obstruction.

The second layer of filtering may use the individual error computations for each measurement from the localization algorithm. The standard deviation for the errors of all the measurements may be computed. A threshold of 1.5 may be optimal for rejecting bad measurements. Any measurements with errors outside of 1.5 standard deviations of the mean of the errors may be rejected, and the localization may be performed again.

The final layer of filtering may be a simple 5 point moving average filter. If the last six points are 1, 2, 3, 4, 5, 6 and if a moving average filter is applied, this approach results in 2 points: one that is the average of the first 5 and the other that is the average of the last five. For example, the first average may be derived as (1+2+3+4+5)/5=3 and the second average may be derived as (2+3+4+5+6)/5=4. For a sequence of three-dimensional (3D) points this is performed for each axis (X, Y, Z) and the result is the filtered position. The last 5 positions taken may be kept in a list. At the end of each ranging session, the average of the last 5 measured positions may be taken and used as the user's position.

Aspects of the map generation algorithm will now be discussed. The required small weight and size of the tag device coupled with the long battery life may place certain design constraints on the algorithms to be used in path planning and localization. The user may need low latency feedback, while the device maintains low power usage by working with limited compute resources.

A set of geometry in the form of line segments may be fed into a preprocessing algorithm to create a navigation map. These line segments currently come from either CAD drawings or a user application that may collect geometry from user input and the tag's position, allowing the user to map out a space with the device itself. For example, an application may be used to draw the area geometry by walking around with a tag and connecting points in space by recording where the tag is when it is near an obstacle. And, if there was a rectangular table in the space, a user would walk to each corner and mark subsequent points. This would be processed as four line segments indicating some obstacle.

A grid size and the geometry may be used to create a grid-based map of the area to be navigated. The minimum and maximum bounds of the area may be found from the geometry, and that area may be divided up into cells of grid size. The grid size used may be 0.5 meters, which may provide a good compromise between being able to navigate accurately though narrow doorways and computational complexity.

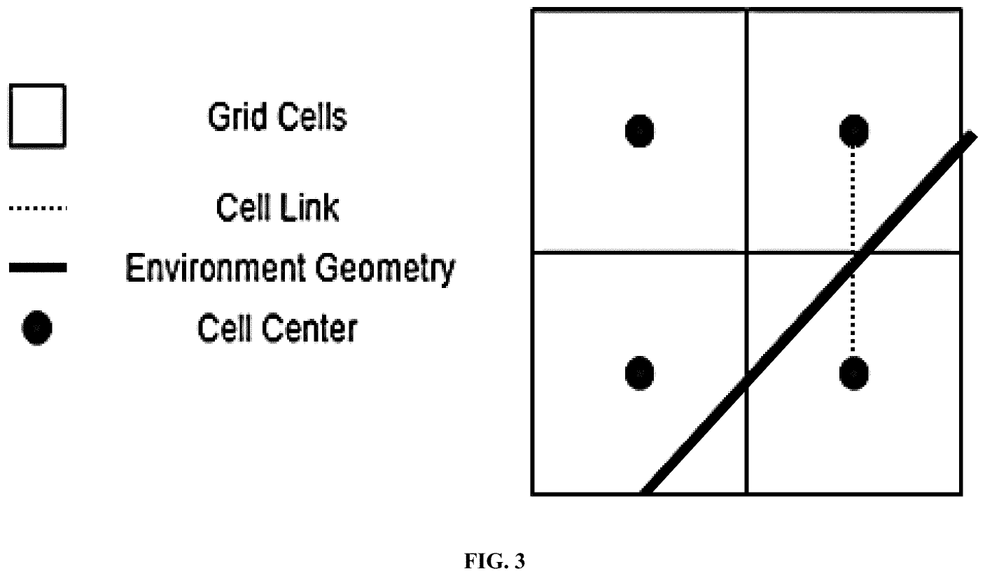

For each connection between grid cells, a heuristic weighting for the traversability of the space between those cells may be calculated. If there is a geometry line segment that intersects with the line segment between the centers of the two cells, the path may be considered unable to be crossed. FIG. 3 exemplarily illustrates this. That is, the line segment between cells (dotted cell link line) is intersecting with some line segment that is part of the environment geometry (solid, thicker line). This exemplarily means that the cell link cannot be traversed and is removed from the map.

The next consideration may be the distance to the nearest obstacle (i.e. line segment). If there is nothing within 1.5 meters of the path, the path may be considered to be unobstructed, and it may receive the lowest (best) weighting value. If an obstacle is between 0 and 1.5 meters, the weight may be scaled linearly from the best possible at 1.5 meters with a weighting value of 1, or the worst possible value with a distance of just over 0 meters with a weighting value of 15.

Once all the values of the weights between the grid cells are determined, a map file may be created. The file may be saved as a matrix of grid cell weight values where each weight grid cell has four weights (i.e., one for each cardinal direction). In addition to the weights, some metadata may be saved in this file, such as the grid size and X,Y coordinates of the corner of the map. This may allow the X,Y coordinates to be translated into a map index (e.g., offset of the weights in the weights matrix that correspond to the X,Y coordinates).

Once this process is completed, there may be areas of the map that may be unreachable (e.g., grid cells inside of geometry with no openings). These may be areas that should not be considered, when doing navigation. If the user location is shown to be in one of these areas, it may be likely in error. A user selected point (currently chosen to be the position of the first point of interest in the core map) may be used to cull the unreachable geometry. The core is meant to differentiate the navigation map, which contains edge weights for moving from cell to cell, from the map it is derived, which contains area geometry and points of interest. Starting from the chosen point, the weights matrix may be traversed using a breadth first search where only grid connections whose weighting indicates that it is traversable and that it thus may be explored. Once this is completed, any cells not in the list of explored cells may have their weights set to untraversable, and they may be marked as not-navigable.

Additional metadata may be required for region-based navigation. The core map data may contain polygons, which form the regions. A second matrix of region identifiers (IDs) may be created. Its offsets may correspond to the same map indexes as the previous matrix. For each cell in this matrix, its center coordinates may be tested to see if they are inside of the polygon for each region. The first region the cell found to be contained within ID may be written into the matrix.

The goal of this map generation may be to produce a small map that may be fit into random access memory (RAM) on an embedded system, allowing for rapid evaluation of the heuristic (e.g., it may be simply read from the matrix directly) to enable path planning on the constrained system. This file may be downloaded into the flash memory of the tag and loaded into RAM, when needed for path planning. The map may be as small as it can reasonably be made for a given area size. For exemplary hardware, this may amount to less than 1 megabytes (MB) of map data, which will fit in the interval memory. The map can be said to use 2 bytes (B) of data per grid cell. Thus, depending on grid cell size (e.g., typical ½ meter), the approach may result in a data density of 8 B per square meter of map area.

Aspects of the path planning algorithm will now be discussed. The path planning algorithm may be an implementation of A* with the heuristic integrated into the preprocessed map data.

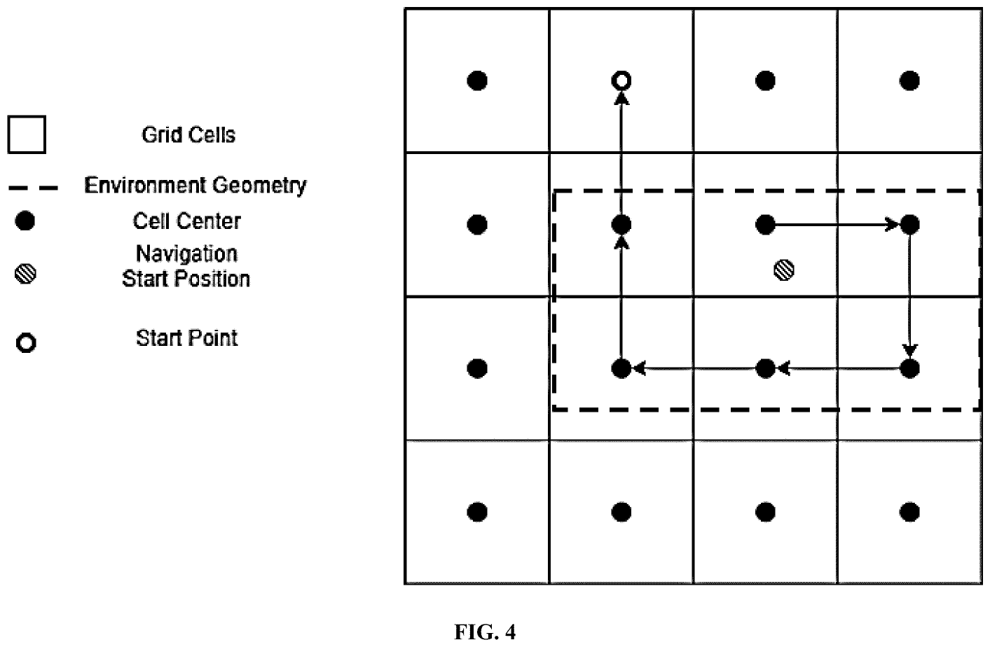

Path planning may fall into two categories: navigating to a coordinate; and navigating to a region. In the case where the start/destination is a coordinate, the first step may be to convert the coordinates into a map index. This cell may be checked for connectivity. If all weights indicate it has no connections, a spiral search may begin to find the nearest connected cell. FIG. 4 exemplarily illustrates this. That is, when a cell is enclosed in some geometry (e.g., a table), that cell is disconnected from the map graph and cannot be navigated from. To find a cell that is in the map graph, the approach is to do a spiral search. Starting from the cell presently in, the disclosed approach searches outwards and around (e.g., following arrows) until a navigable cell is found (start point).

An algorithm loops out in a square spiral taking steps in the cardinal directions in the grid until it finds a connected cell. This cell map index may be used as the start/end of the search.

For region navigation, a different end criteria may be defined for the search. The value in the region ID matrix at the location of the currently explored map index may be checked against the ID of the goal region. If they match, this may be considered to be the end of the path to the region. For example, simple numerical indexed values may be used, such as with each region being assigned an ID starting from 1. In another example having 4 regions with IDs 1, 2, 3, 4 and to save space, an approach may currently only support 255 regions in a map, using a 1 B per grid cell to store its region.

A* path-planning may generally comprise several structures: a list of explored states; a priority queue of states to be explored (frontier) ordered by the cost of traversing the path; and some mechanism to remember the path taken to each frontier node. An explored state may simply be a grid cell, and it may be indicated by a map index. It may be added to the explored list to indicate the algorithm as traversed that cell. The path traversal cost may be based on the weights in the map and on an additional cost of 1, which may be added for any traversal.

Some embodiments may cause reduction in the RAM utilization, during the path planning. The frontier node objects' recycling may be one aspect that results in a reduced RAM utilization. All the data structures were chosen as to reduce RAM consumption (e.g., using a bit array as the explored list rather than a list of map indexes). If the map needs to be fully explored, a list of map indexes may be 16× larger than a bit array. The explored list may be implemented as a bit array, with each map index corresponding to a single bit. One bit may indicate that a cell had been explored. A pre-allocated bag of frontier nodes may be created to pre-constrain memory use and allow rapid allocation of objects to hold the frontier data. Because all the objects are pre-allocated, this approach may be guaranteed to never run out of memory in operation.

In some implementations, the path back may be stored in pointers in the frontier back to other nodes that were previously in the frontier, but this may have a high memory cost. Instead, an array may be created to store the flow from the frontier nodes back to the start. It may be a matrix with the same dimensions as the map, which stores the direction to the cell that resulted in this frontier node. This may allow recycling of the frontier node objects back into the bag. This may have additional benefits for other uses of the path planning (e.g., it may accelerate the calculation of walking distances to a list of points of interest). Since the approach may need to calculate multiple paths to find walking distance to all POIs, a naive approach would be to simply run the algorithm once for each POI. By storing the path back as a flow, the approach may compute any path to the start from any explored endpoint by following the flow directions from the end point. Now the approach only needs to run the path search once until all POI endpoints are explored, and it may count the number of grid cells for each endpoint back to the start.

The first step of A* may be to create an origin frontier node. This may be pushed into the frontier list, and the algorithm may be started. For each node explored, if it is not a terminal node, the device may evaluate each cardinal direction as a potential extension to the path. Each frontier node may store current path cost. The weight of traversing to the adjacent grid cell may be added to the current path cost. The new frontier node may contain its map index, the previous cells map index, and the path cost. When it is explored, the previous index combined with the current may be used to set the value of the corresponding element in the flow matrix, keeping track of the path back to the origin. An additional consideration may be made for cells that are diagonal to the current cell. To save on memory, direct weighting of the diagonal connections may not be saved. Instead, the weight of two adjacent moves may be considered. For example, up/down moves and then left/right moves. The worst-case weighting may be looked at and half the value may be used as the cost of making a diagonal step. The addition of the diagonal moves may produce more direct and natural paths. The new frontier nodes may then be inserted into the frontier priority queue. The priority queue may be implemented as a doubly-linked list. Insertions may involve traversing the list from the back, until the new nodes cost is less than the current node form the list.

Once the end is found, a loop may traverse the flow matrix from the end following the path back until it reaches the starting map index. At each step, it may add the current map index to a list. Upon completion, the list may be reversed, and the device may have a path composed of map indexes from the start to the destination.

Aspects of the POI walking distance calculation will now be discussed. In addition to computing paths to desired destinations, the path planning may also be used to compute walking distances to the POIs in the local area. The end criteria of the path planning may be adjusted so that it only terminates once all POIs have been reached. Then, paths may be generated using the flow matrix for each of the POIs. The walking distance to the POI may then be simply the number of segments in each path times the grid spacing. This approach may cause reduction in computation time, when compared with running the entire algorithm multiple times, once for each POI.

Aspects of the navigation algorithm will now be discussed. Navigation may take in a path to follow, the user's current position, and the user's current heading. It may output feedback in the form of an angle error between the desired and actual heading. The angle error may be the angular difference between the users orientation as known by the inertial measurement unit (IMU) and the desired heading. The desired heading may be defined to be the angle of the vector from the users current position, and several steps forward (e.g., 3), along the computed navigation path.

For each position update, the distance from the users position to each segment in the path may be calculated. If the user is within 1 meter of the final path segment, navigation may be terminated. The segment 1.5 meters ahead of the nearest segment may be considered the goal to be reached. In the case of a 0.5 meter grid, this may be 3 segments ahead in the path. The angle between the users position and the position of the further path segment may be calculated and used as the desired heading.

The users current heading may be read from the tag's IMU. The difference between the desired and current heading may be used to generate haptic feedback.

Aspects of the haptic feedback will now be discussed. Haptic feedback may be produced by two vibration motors 65. These motors may be mounted in a vest one on each side of the user's body. On-course feedback may be pulsing to indicate to the user the device is functioning. The on-course signal may be for both motors to be pulsing. If the user has deviated to the left or the right, the corresponding motor may change from pulsing to solid, indicating a correction of turning away from the solid vibration is required to get back on course. In the case of being turned towards the wrong direction, both motors may change to solid vibrations indicating to the user to turn around 180 degrees.

A system with limited and distinct feedback states (e.g., left, right, strait, etc.) may be easier to follow than a system with granular feedback, without allowing the user to drift off course enough to run into obstacles. In the space of possible feedback, there may be a continuous potential feedback, i.e., having some angle between 0-360 degrees, which can be represented by a haptic intensity, i.e., an unlimited set of feedback states. By contrast, limiting this to a set of only four discrete states (i.e. left, right, strait, and turn-around) is a limited set of states.

Aspects of the buddy functionality will now be discussed. Buddy functionality may be enabled using a second backhaul radio with longer range capability than the ranging radios. This link may serve to reduce the utilization of the ranging channels and may allow for direct communication of distant tags. Direct communication may reduce the chance of network failure leading to a failure of the buddy functionality.

The user may scan a tag using a mobile phone's NFC functionality. The ID in that NFC tag may be set as the buddy. Whenever the user requests the buddy's position, a message may be sent to that buddy's address over the backhaul radio and a response with the buddy tags position may be sent.

Some embodiments may use the IMU acceleration and orientation data to be fused using an extended Kalman filter (EKF) or particle filter with the estimated position data. This may provide more accurate short-term position data and may be used to correct for heading drift over the longer term. The IMU may provide a much higher update rate than the ranging radio, but it may not provide absolute position information. Its acceleration data may, however, be integrated with time and fused with the absolute position data to give it a zero-reference. This may allow it to fill in the gaps between ranging updates. From the estimated position data over time, one can derive a walking direction. This walking direction can be considered to be a more accurate estimate of the user heading. By looking at the difference between this estimate and the IMU estimate, an error for the current IMU estimate can be derived. This can then be used to compensate for the IMU error/drift, e.g., when the user is not moving and therefore the heading estimate based on motion is no longer available.

Some embodiments may implement multi-level/multi-area path planning. The current path planner may be limited in the maximum size of the grid it may navigate through. Connecting multiple maps/multiple levels with constrained entrance/exits and doing a multilayer path planning approach may allow for much larger areas to be navigated without significant changes to current hardware or computational complexity. On the lowest level, the A* traverses a graph that may be a representation of how the grid exists in real space. If the areas of real space are subdivided, a larger graph of how to move between spaces can be created. At this level, all the detail of the lower level can be ignored. This may allow path planning of a very large area to be done in a 2 step process. First, one may plan movements between the larger areas (e.g., first 2 second floor). Then, one may plan the paths in each sub areas from where one is in one to the entry way of the next.

Some embodiments may implement map download from local anchors. This may improve the system robustness by letting the tag adapt to any area it entered by downloading the local map directly from any nearby anchor. The device may not have to keep a database of maps downloaded but instead may get the local map when entering a new area.

Some embodiments may use multiple DW1000 chips/phased array antennas. The DW1000 chipset may support multichip synchronization. Using a quad antenna phased array may allow for direction and distance information to be extracted from each anchor. This may result in easier outlier detection and more accurate solutions. In addition, having 2 antennas (e.g., one on each side of the user) may prevent attenuation of the line-of-sight path from the users head and may allow better measurements. By having more information, the outliers may be made more apparent. Before, one had to use the error relative to the standard deviation of all errors to decide if a measurement was bad. Now, one has the additional data of what direction the signal came from. And, if this does not correspond well with the position estimate, this may give better and more evidence that a measurement is bad and should be filtered.

Artificial neural networks (ANNs) are models used in machine learning and may include statistical learning algorithms conceived from biological neural networks (particularly of the brain in the central nervous system of an animal) in machine learning and cognitive science. ANNs may refer generally to models that have artificial neurons (nodes) forming a network through synaptic interconnections (weights), and acquires problem-solving capability as the strengths of the interconnections are adjusted, e.g., at least throughout training. The terms ‘artificial neural network’ and ‘neural network’ may be used interchangeably herein.

An ANN may be configured to determine a classification (e.g., type of object) based on input image(s) or other sensed information. An ANN is a network or circuit of artificial neurons or nodes. Such artificial networks may be used for predictive modeling.

The prediction models may be and/or include one or more neural networks (e.g., deep neural networks, artificial neural networks, or other neural networks), other machine learning models, or other prediction models. As an example, the neural networks referred to variously herein may be based on a large collection of neural units (or artificial neurons). Neural networks may loosely mimic the manner in which a biological brain works (e.g., via large clusters of biological neurons connected by axons). Each neural unit of a neural network may be connected with many other neural units of the neural network. Such connections may be enforcing or inhibitory, in their effect on the activation state of connected neural units. These neural network systems may be self-learning and trained, rather than explicitly programmed, and may perform significantly better in certain areas of problem solving, as compared to traditional computer programs. In some embodiments, neural networks may include multiple layers (e.g., where a signal path traverses from input layers to output layers). In some embodiments, back propagation techniques may be utilized to train the neural networks, where forward stimulation is used to reset weights on the front neural units. In some embodiments, stimulation and inhibition for neural networks may be more free-flowing, with connections interacting in a more chaotic and complex fashion.

Disclosed implementations of artificial neural networks may apply a weight and transform the input data by applying a function, this transformation being a neural layer. The function may be linear or, more preferably, a nonlinear activation function, such as a logistic sigmoid, Tan h, or rectified linear activation function (ReLU) function. Intermediate outputs of one layer may be used as the input into a next layer. The neural network through repeated transformations learns multiple layers that may be combined into a final layer that makes predictions. This learning (i.e., training) may be performed by varying weights or parameters to minimize the difference between the predictions and expected values. In some embodiments, information may be fed forward from one layer to the next. In these or other embodiments, the neural network may have memory or feedback loops that form, e.g., a neural network. Some embodiments may cause parameters to be adjusted, e.g., via back-propagation.

An ANN is characterized by features of its model, the features including an activation function, a loss or cost function, a learning algorithm, an optimization algorithm, and so forth. The structure of an ANN may be determined by a number of factors, including the number of hidden layers, the number of hidden nodes included in each hidden layer, input feature vectors, target feature vectors, and so forth. Hyperparameters may include various parameters which need to be initially set for learning, much like the initial values of model parameters. The model parameters may include various parameters sought to be determined through learning. And the hyperparameters are set before learning, and model parameters can be set through learning to specify the architecture of the ANN.

Learning rate and accuracy of an ANN rely not only on the structure and learning optimization algorithms of the ANN but also on the hyperparameters thereof. Therefore, in order to obtain a good learning model, it is important to choose a proper structure and learning algorithms for the ANN, but also to choose proper hyperparameters.

The hyperparameters may include initial values of weights and biases between nodes, mini-batch size, iteration number, learning rate, and so forth. Furthermore, the model parameters may include a weight between nodes, a bias between nodes, and so forth.

In general, the ANN is first trained by experimentally setting hyperparameters to various values, and based on the results of training, the hyperparameters can be set to optimal values that provide a stable learning rate and accuracy.

Some embodiments of models 60-2 may comprise a convolutional neural network (CNN). A CNN may comprise an input and an output layer, as well as multiple hidden layers. The hidden layers of a CNN typically comprise a series of convolutional layers that convolve with a multiplication or other dot product. The activation function is commonly a RELU layer, and is subsequently followed by additional convolutions such as pooling layers, fully connected layers and normalization layers, referred to as hidden layers because their inputs and outputs are masked by the activation function and final convolution.

The CNN computes an output value by applying a specific function to the input values coming from the receptive field in the previous layer. The function that is applied to the input values is determined by a vector of weights and a bias (typically real numbers). Learning, in a neural network, progresses by making iterative adjustments to these biases and weights. The vector of weights and the bias are called filters and represent particular features of the input (e.g., a particular shape).

A recurrent neural network (RNN) is a class of artificial neural networks where connections between nodes form a directed graph along a temporal sequence. Temporal dynamic behavior can be shown from the graph. RNNs employ internal state memory to process variable length sequences of inputs. RNN's can perform tasks such as unsegmented handwriting recognition, connected handwriting recognition, and speech recognition.

In some embodiments, the learning of models 60-2 may be of reinforcement, supervised, and/or unsupervised type. For example, there may be a model for certain predictions that is learned with one of these types but another model for other predictions may be learned with another of these types.

Reinforcement learning is a technique in the field of artificial intelligence where a learning agent interacts with an environment and receives observations characterizing a current state of the environment. Namely, a deep reinforcement learning network is trained in a deep learning process to improve its intelligence for effectively making predictions. The training of a deep learning network may be referred to as a deep learning method or process. The deep learning network may be a neural network, Q-learning network, dueling network, or any other applicable network.

Reinforcement learning may be based on a theory that given the condition under which a reinforcement learning agent can determine what action to choose at each time instance, the agent can find an optimal path to a solution solely based on experience of its interaction with the environment. For example, reinforcement learning may be performed mainly through a Markov decision process (MDP). MDP may comprise four stages: first, an agent is given a condition containing information required for performing a next action; second, how the agent behaves in the condition is defined; third, which actions the agent should choose to get rewards and which actions to choose to get penalties are defined; and fourth, the agent iterates until a future reward is maximized, thereby deriving an optimal policy.

Deep reinforcement learning (DRL) techniques capture the complexities of the RF environment in a model-free manner and learn about it from direct observation. DRL can be deployed in different ways such as for example via a centralized controller, hierarchal or in a fully distributed manner. There are many DRL algorithms and examples of their applications to various environments. In some embodiments, deep learning techniques may be used to solve complicated decision-making problems in wireless network optimization. For example, deep learning networks may be trained to adjust one or more parameters of a wireless network, or a plurality of cells in the wireless network so as to achieve optimization of the wireless network with respect to an optimization goal.

Supervised learning is the machine learning task of learning a function that maps an input to an output based on example input-output pairs. It may infer a function from labeled training data comprising a set of training examples. In supervised learning, each example is a pair consisting of an input object (typically a vector) and a desired output value (the supervisory signal). A supervised learning algorithm analyzes the training data and produces an inferred function, which can be used for mapping new examples. And the algorithm may correctly determine the class labels for unseen instances.

Unsupervised learning is a type of machine learning that looks for previously undetected patterns in a dataset with no pre-existing labels. In contrast to supervised learning that usually makes use of human-labeled data, unsupervised learning does not via principal component (e.g., to preprocess and reduce the dimensionality of high-dimensional datasets while preserving the original structure and relationships inherent to the original dataset) and cluster analysis (e.g., which identifies commonalities in the data and reacts based on the presence or absence of such commonalities in each new piece of data). Semi-supervised learning is also contemplated, which makes use of supervised and unsupervised techniques.

Prediction/optimization component 36 of FIG. 1 may prepare one or more prediction models to generate predictions. Models 60-2 may analyze made predictions against a reference set of data called the validation set. In some use cases, the reference outputs may be provided as input to the prediction models, which the prediction model may utilize to determine whether its predictions are accurate, to determine the level of accuracy or completeness with respect to the validation set data, or to make other determinations. Such determinations may be utilized by the prediction models to improve the accuracy or completeness of their predictions. In another use case, accuracy or completeness indications with respect to the prediction models' predictions may be provided to the prediction model, which, in turn, may utilize the accuracy or completeness indications to improve the accuracy or completeness of its predictions with respect to input data. For example, a labeled training dataset may enable model improvement. That is, the training model may use a validation set of data to iterate over model parameters until the point where it arrives at a final set of parameters/weights to use in the model.

In some embodiments, prediction/optimization component 36 may implement an algorithm for building and training one or more deep neural networks. A used model may follow this algorithm and already be trained on data. In some embodiments, prediction/optimization component 36 may train a deep learning model on training data 60-1 providing even more accuracy, after successful tests with these or other algorithms are performed and after the model is provided a large enough dataset.

A model implementing a neural network may be trained using training data obtained by prediction/optimization component 36 from training data 60-1 storage/database. The training data may include many attributes of a plurality of users previously moving through spaces. For example, this training data obtained from prediction database 60 of FIG. 1 may comprise hundreds, thousands, or even many millions of pieces of information (e.g., images or other sensed data) describing people and objects. The dataset may be split between training, validation, and test sets in any suitable fashion. For example, some embodiments may use about 60% or 80% of the images for training or validation, and the other about 40% or 20% may be used for validation or testing. In another example, prediction/optimization component 36 may randomly split the labelled images, the exact ratio of training versus test data varying throughout. When a satisfactory model is found, prediction/optimization component 36 may train it on 95% of the training data and validate it further on the remaining 5%.

The validation set may be a subset of the training data, which is kept hidden from the model to test accuracy of the model. The test set may be a dataset, which is new to the model to test accuracy of the model. The training dataset used to train prediction models 60-2 may leverage, via prediction/optimization component 36, an SQL server and a Pivotal Greenplum database for data storage and extraction purposes.

In some embodiments, prediction/optimization component 36 may be configured to obtain training data from any suitable source, via electronic storage 22, external resources 24 (e.g., which may include sensors), network 70, and/or UI device(s) 18. The training data may comprise captured images, smells, light/colors, shape sizes, noises or other sounds, and/or other discrete instances of sensed information.

In some embodiments, prediction/optimization component 36 may enable one or more prediction models to be trained. The training of the neural networks may be performed via several iterations. For each training iteration, a classification prediction (e.g., output of a layer) of the neural network(s) may be determined and compared to the corresponding, known classification. For example, sensed data known to capture a closed environment comprising dynamic and/or static objects may be input, during the training or validation, into the neural network to determine whether the prediction model may properly predict a path for the user to reach or avoid said objects. As such, the neural network is configured to receive at least a portion of the training data as an input feature space. Once trained, the model(s) may be stored in database/storage 60-2 of prediction database 60, as shown in FIG. 1, and then used to classify samples of images based on visible attributes.

In some embodiments, models 60-2 may determine in real-time that an average pace of the user is less than at least an average page of a subset of the other users. This model may then predict, based on the determination, a better path such that the user is directed to or near a set of the POIs. And this direction may be performed with one or more actuators that actuate the user based on the prediction.

In some embodiments, models 60-2 may determine in real-time that an amount of people and/or objects in the closed environment satisfies a congestion criteria. This model may then predict, based on the determination, a better path such that the user is directed to or near a set of the POIs. And this direction may be performed with one or more actuators that actuate the user based on the prediction.

In some embodiments, models 60-2 may determine in real-time that (i) locations of the POIs traversed by the user, on or near the path, satisfies one or more first criteria and (ii) an amount of time spent by the user, at or near the locations, satisfies one or more second criteria. This model may then predict, based on the determination, a better path. One or more actuators may then be used to actuate the user based on the prediction.

In some embodiments, models 60-2 may determine in real-time that a number of users of a subset of the other users (e.g., in a same environment) satisfies a popularity criterion, wherein each of the subset of the other users has previously moved to or near one or more of the POIs in the closed environment. This model may then predict, based on the determination, a better path to the one or more POIs such that the user is directed thereto. And this direction may be performed with one or more actuators that actuate the user based on the prediction, this actuation being of a different type or pattern from any previously disclosed actuation. For example, this different type of actuation may add weight to what is highlighted to the user as well as guide them close or far from popular exhibits during path planning.

In some embodiments, models 60-2 may predict one or more turns (e.g., alone or part of an intended path) relative to an environment comprising a plurality of statically-located POIs and anchor transceivers. The user may then be actuated based on the one or more predictions such that the user approaches at least one of the POIs.

In some embodiments, models 60-2 may predict in real-time optimal distances between the user and at least a subset of the other users. And then one or more actuators may actuate the user such that the user moves through the path in communicative coordination with actuators worn on the subset of the other users.

In some implementations, a path may be predicted such that the user is operable to walk the path within a predetermined amount of time.

In some implementations, a path is predicted and the actuation caused such that the user is directed to the POIs based on a theme or topic associated with each of the POIs.

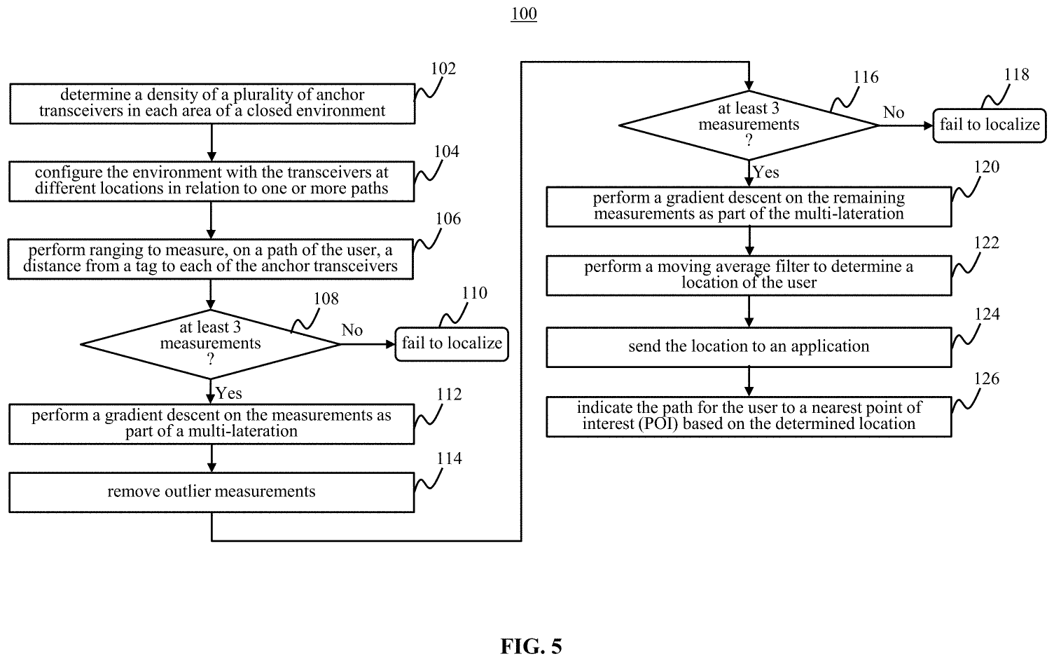

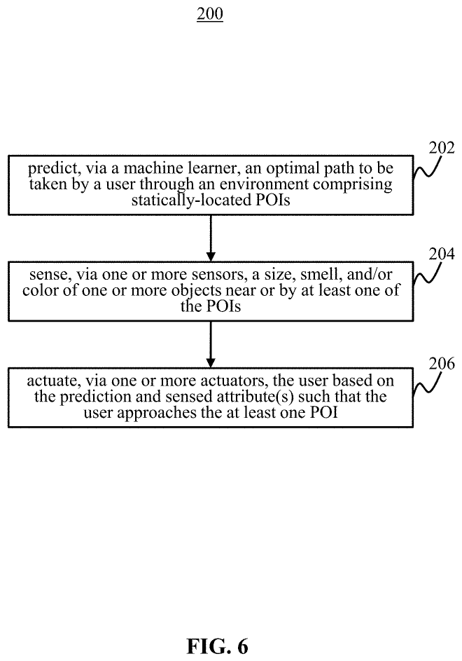

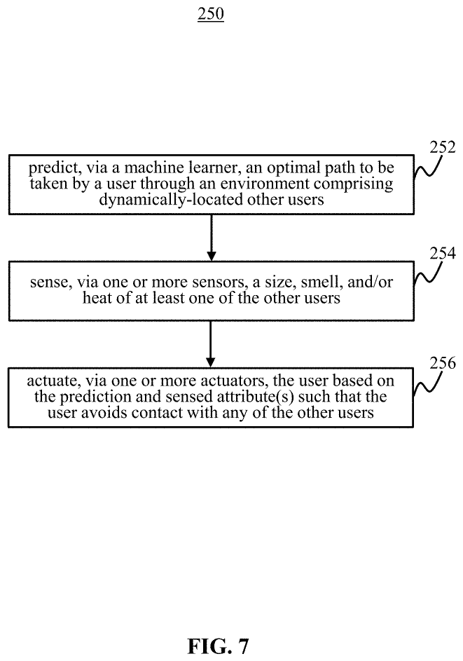

FIG. 5 illustrates method 100 for directing a user to one or more POIs, in accordance with one or more embodiments. And FIGS. 6-7 respectively illustrate methods 200 and 250 for directing the user to at least one POI and for directing the user (e.g., along a path) such that the user avoids accidental contact. These methods may be performed with a computer system comprising one or more computer processors and/or other components. The processors are configured by machine readable instructions to execute computer program components. The operations of these methods, which are presented below, are intended to be illustrative. In some embodiments, methods 100, 200, and 250 may each be accomplished with one or more additional operations not described, and/or without one or more of the operations discussed. Additionally, the order in which the operations of each of these methods are illustrated in FIGS. 5-7 and described below is not intended to be limiting. In some embodiments, each of methods 100, 200, and 250 may be implemented in one or more processing devices (e.g., a digital processor, an analog processor, a digital circuit designed to process information, an analog circuit designed to process information, a state machine, and/or other mechanisms for electronically processing information). The processing devices may include one or more devices executing some or all of the operations of these methods in response to instructions stored electronically on an electronic storage medium. The processing devices may include one or more devices configured through hardware, firmware, and/or software to be specifically designed for execution of one or more of these operations.

At operation 102 of method 100, a density of a plurality of anchor transceivers may be determined, e.g., in a plurality of areas of a closed environment. As an example, a density of the anchors 55 may be determined for a first area of a closed environment. In this or another example, a density of other anchors 55 may be determined for a second, different area of the closed environment. A tradeoff may be analyzed such that only a minimum number of anchors 55 for a guaranteed quality of experience is calculated. In some embodiments, operation 102 is performed by a processor component the same as or similar to anchor configuration component 32 (shown in FIG. 1 and described herein).

At operation 104 of method 100, the environment may be configured, e.g., with the anchor transceivers being at different locations in relation to one or more potential paths a user may take. As an example, anchors 55 may be preconfigured in place, or they may dynamically learn optimal locations based on objects of the environment; the resulting density may be characterized. In some implementations, the space in which the user is guided may be an enclosed space. In other implementations, the space may be open or outdoors. In these or other implementations, anchors 55 may be configured such that a transition from an inside space to an outside space (or vice versa) is supported. In some embodiments, operation 104 is performed by a processor component the same as or similar to anchor configuration component 32 (shown in FIG. 1 and described herein).

At operation 106 of method 100, ranging may be performed, e.g., to measure a distance from a tag, on a path of the user, to each of the anchor transceivers 55. In some embodiments, operation 106 is performed using antennas 50 and by a processor component the same as or similar to anchor configuration component 32 (shown in FIG. 1 and described herein).

At operation 108 of method 100, it may be determined whether at least 3 measurements have been obtained. The example of FIG. 2 shows 3 measurements taken based on use of 3 anchors 55. But some implementations may be operable with at least two anchors, others operating instead with at least three anchors or with four or more anchors. If there are only 2 anchors 55 configured for operation in an environment, then location determination component 34 may need to make a guess, as there may be 2 possible intersection locations of their radiated arcs/rings. In some embodiments, operation 108 is performed by a processor component the same as or similar to location determination component 34 (shown in FIG. 1 and described herein).

At operation 110 of method 100, a failure state may be determined in attempting to localize the user. In some embodiments, operation 110 is performed by a processor component the same as or similar to location determination component 34 (shown in FIG. 1 and described herein).

At operation 112 of method 100, a gradient descent may be performed, e.g., on the measurements as part of a multi-lateration algorithm. In some embodiments, operation 112 is performed by a processor component the same as or similar to location determination component 34 (shown in FIG. 1 and described herein).

At operation 114 of method 100, outlier measurements may be removed. In some embodiments, operation 114 is performed by a processor component the same as or similar to location determination component 34 (shown in FIG. 1 and described herein).

At operation 116 of method 100, it may be determined whether at least 3 other measurements have been obtained. In some embodiments, operation 116 is performed by a processor component the same as or similar to location determination component 34 (shown in FIG. 1 and described herein).

At operation 118 of method 100, a failure state may be determined in attempting to localize the user. In some embodiments, operation 118 is performed by a processor component the same as or similar to location determination component 34 (shown in FIG. 1 and described herein).

At operation 120 of method 100, a gradient descent may be performed again, e.g., on the remaining measurements as part of the same multi-lateration algorithm. In some embodiments, operation 120 is performed by a processor component the same as or similar to location determination component 34 (shown in FIG. 1 and described herein).

At operation 122 of method 100, a moving average filter may be performed, e.g., to determine a location of the user. In some embodiments, operation 122 is performed by a processor component the same as or similar to location determination component 34 (shown in FIG. 1 and described herein).

At operation 124 of method 100, the location may be sent to an application. As an example, an application utilizing outputs from location determination component 34 and path indication component 38 may obtain the location such that the user is guided to POIs.

At operation 126 of method 100, the path may be indicated, e.g., for the user to a nearest POI based on the determined location. As an example, the user may be guided with a haptic or sonic actuator. In some embodiments, operation 126 is performed by a processor component the same as or similar to path indication component 38 (shown in FIG. 1 and described herein).

At operation 202 of method 200, an optimal path to be taken by a user, through an environment comprising POIs, may be predicted using a machine learner. As an example, a trained model may be used to make one or more predictions. The POIs may each be an area of interest or attraction. And the POIs may be statically located or mobile. For example, In some implementations, the user may veer so far off course (or the destination moves, as is the case in buddy navigation) that the path needs to be re-planned or re-predicted. In some embodiments, operation 202 is performed by a processor component the same as or similar to prediction/optimization component 36 (shown in FIG. 1 and described herein).

At operation 204 of method 200, a size, smell, noise, and/or color of one or more objects near or by at least one of the POIs may be sensed using one or more sensors. As an example, a sensor of external resources 24 may output signals indicative of nearby presence of objects of different types. The foregoing prediction may be made based on the sensed data indicating certain patterns.

At operation 206 of method 200, the user may be actuated using one or more actuators based on the prediction and sensed attribute(s) such that the user approaches the at least one POI. As an example, the user may be guided with a haptic or sonic actuator. In some embodiments, prediction/optimization component 36 may update a prediction based on a comfort or speed parameter of the user (e.g., which may be received via UI device 18). For example, a user may indicate that they would like to reach a POI with minimal interaction with other users and/or at a pace that is relatively or comparatively slow. In another example, the user may indicate that they would like to reach a destination POI as fast as possible, including the likely possibility of contacting a person or bumping against another object. In some embodiments, operation 206 is performed by a processor component the same as or similar to path indication component 38 (shown in FIG. 1 and described herein).

At operation 252 of method 250, an optimal path to be taken by a user, through an environment comprising dynamically-located other users, may be predicted using a machine learner. As an example, a model (e.g., which may have been trained using previous movements performed in the same or one or more other environments) may be used to make one or more predictions. In some embodiments, upon obtaining a request, an optimal path may be built between the two points (e.g., starting and ending locations) and the haptic feedback functions to keep the user on this path independent of their speed. In other embodiments, the optimal path is continually re-built to keep the user on this path based on speed and/or one or more other conditions (e.g., congestion, updated key areas of interest, speed of other users, and/or another suitable constraint). In some embodiments, operation 252 is performed by a processor component the same as or similar to prediction/optimization component 36 (shown in FIG. 1 and described herein).

At operation 254 of method 250, a size, smell, noise, and/or heat of at least one of the other users may be sensed using one or more sensors. As an example, a sensor of external resources 24 may output signals indicative of nearby presence of different people. The foregoing prediction may be made based on the sensed data indicating certain patterns.

At operation 256 of method 250, the user may be actuated using one or more actuators based on the prediction and sensed attribute(s) such that the user avoids contact with any of the other users. As an example, the user may be guided with a haptic or sonic actuator. In some implementations, the coordinated actuation may ensure that the user and at least one of the other users do not come into substantially close proximity or block an attempt of the user at seeing a same set of attractions. Indeed, communicative coordination among systems 10 may comprise the positional data of each of these users being made available to each other system 10 and may be coordinated to avoid collisions. In some embodiments, operation 256 is performed by a processor component the same as or similar to path indication component 38 (shown in FIG. 1 and described herein).

Techniques described herein can be implemented in digital electronic circuitry, or in computer hardware, firmware, software, or in combinations of them. The techniques can be implemented as a computer program product, i.e., a computer program tangibly embodied in an information carrier, e.g., in a machine-readable storage device, in machine-readable storage medium, in a computer-readable storage device or, in computer-readable storage medium for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps of the techniques can be performed by one or more programmable processors executing a computer program to perform functions of the techniques by operating on input data and generating output. Method steps can also be performed by, and apparatus of the techniques can be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, such as, magnetic, magneto-optical disks, or optical disks. Information carriers suitable for embodying computer program instructions and data include all forms of non-volatile memory, including by way of example semiconductor memory devices, such as, EPROM, EEPROM, and flash memory devices; magnetic disks, such as, internal hard disks or removable disks; magneto-optical disks; and CD-ROM and DVD-ROM disks. The processor and the memory can be supplemented by, or incorporated in special purpose logic circuitry.

Several embodiments of the disclosure are specifically illustrated and/or described herein. However, it will be appreciated that modifications and variations are contemplated and within the purview of the appended claims.

What is claimed is:

1. A method, comprising:
determining a location of a user by walking down an error surface, until reaching a minimum, the error surface having a length represented by a brightness of a rendering; and
indicating a path for the user to a nearest point of interest (POI) based on the determined location.

2. The method of claim 1, wherein the walking down is performed to minimize error based on a gradient descent, the surface being defined by a sum of squares of errors of each measurement of one anchor transceiver based on a position of the one anchor transceiver.

3. The method of claim 1, further comprising:
providing the indication via haptic or sonic feedback to the user based on the determined user location.

4. The method of claim 1, further comprising:
configuring a closed environment with a plurality of anchor transceivers at different locations;
providing a radio frequency (RF) tag integrated in a wearable garment to compute a distance to each of the anchor transceivers.

5. The method of claim 4, further comprising:
determining a density of the anchor transceivers for a first area of the closed environment.

6. The method of claim 5, further comprising:
determining a density of other anchor transceivers for a second, different area of the closed environment.

7. The method of claim 4, further comprising:
the computing, via a multi-lateration, of the distances to the anchor transceivers to perform the determination of the user location.

8. The method of claim 7, wherein a precision of the multi-lateration is based on an accuracy of a performed ranging.

9. The method of claim 1, wherein the brightness of the rendering pertains to a shading of a heatmap.

10. A system, for determining a location of a user, comprising a processor (i) embedded in a garment worn by the user and (ii) configured to execute machine-readable instructions from a non-transitory memory to perform:
determining, via a gradient descent, a location of a user; and
indicating the user to a POI based on the determined location.

11. The system of claim 10, wherein a walking down of an error surface, until reaching a minimum, the error surface having a length represented by a brightness of a rendering, is performed to minimize error, and
wherein the surface is defined by a sum of squares of errors of each measurement of one anchor transceiver based on a position of the one anchor transceiver.

12. The system of claim 10, further comprising:
providing the indication via haptic or sonic feedback to the user based on the determined user location.

13. The system of claim 10, further comprising:
providing an RF tag embedded in the garment to compute a distance to each of a plurality of differently-located anchor transceivers.

14. The system of claim 13, further comprising:
determining a density of the anchor transceivers.

15. A system, comprising:
a plurality of anchors configured into different locations of a substantially closed environment; and
a transceiver worn by a user and operable to communicate with the anchors such that a location of the user is determined by walking down an error surface, until reaching a minimum, the error surface having a length represented by a brightness of a rendering, wherein a sensory of the user is indicated to a POI based on the determined location.

16. The system of claim 15, providing the indication via haptic or sonic feedback to the user based on the determined user location.

17. The system of claim 15, further comprising:
configuring a closed environment with a plurality of anchor transceivers at different locations;
providing an RF tag integrated in a wearable garment to compute a distance to each of the anchor transceivers.

18. The system of claim 17, determining a density of the anchor transceivers.

19. The system of claim 17, further comprising:
the computing, via a multi-lateration, of the distances to the anchor transceivers to perform the determination of the user location.

20. The system of claim 19, wherein a precision of the multi-lateration is based on an accuracy of a performed ranging.
